(19) United States
(12) Patent Application Publication
(10) Pub. No.: US 2011/0244826 A1
(43) Pub. Date: Oct. 6, 2011

(54) MOBILE COMMUNICATION PLAN OFFERINGS

(76) Inventors: Subramaniyan Krishnan, Bangalore (IN); Jay Kumar, Bangalore (IN); Shankar Prasad, Bangalore (IN)

(21) Appl. No.: 13/019,999

(22) Filed: Feb. 2, 2011

Related U.S. Application Data
(60) Provisional application No. 61/301,107, filed on Feb. 3, 2010.

(51) Int. Cl. H04M 11/00

(52) U.S. Cl. 455/405

(57) ABSTRACT

A mobile communication plan offering system and method described herein determines one or more best-fit mobile communication plan offers for mobile communication device (“MCD”) users. Subscribers can also be referred to as “mobile subscribers” or “subscribers”. The mobile communication plan offers typically consist of one or more modifications to a plan (also referred to as packs) or a complete plan including a base plan plus a pack and are based on a mobile usage pattern of a subscriber. In at least one embodiment, the mobile communication plan offering system and method analyzes MCD usage behavior of a subscriber, processes the usage behavior and current spending of the subscriber, and determines a mobile communication plan offering that, if adopted, will result in a positive economic benefit to the subscriber compared with the subscriber's current plan.

### CROSS-REFERENCE TO RELATED APPLICATION

This application claims the benefit under 35 U.S.C. §119(e) and 37 C.F.R. §1.78 of U.S. Provisional Application No. 61301107, filed Feb. 3, 2010, and entitled “Mobile Communication Plan Offerings,” and is incorporated by reference in its entirety.

### BACKGROUND OF THE INVENTION

1. Field of the Invention

The present invention relates in general to the field of mobile communication, and, more specifically, to a system and method for offering mobile communication plans.

2. Description of the Related Art

Use of mobile communication devices (“MCDs”), such as mobile telephones, is wide spread. Mobile communication devices are devices that are mobile and can send and receive communication signals such as all mobile phones (also referred to as “cell phones”). Example mobile communication devices are any device that provides mobile telephone capabilities.

MCD users, referred to herein as “subscribers”, “users”, or “MCD users”, can often purchase different types of mobile communication plans, to allow the Subscribers to, for example, conduct calls, send and receive messages (such as short message service (SMS) or multimedia message service (MMS)), and send and receive other data. The mobile communication plans provide the subscriber, for example, a maximum number of call minutes and/or a maximum amount of data, and have a specified duration (often referred to as “validity”). Mobile communication plan pricing can take a variety of forms such as flat fee or usage based such as per minute and/or per megabyte of data.

Subscribers have a variety of ways to select their mobile communication plans. For example, the subscriber can discuss particular mobile communication plans with a sales representative or select a mobile communication plan through a web site. Additionally, mobile communication service providers may send a mobile communication plan offer via an SMS message to a large number of subscribers. The subscribers can respond to the mobile communication plan offer if desired. However, because the mobile communication plan offers are generated for a large segment of users, an individual subscriber may not be able to evaluate the value of the offer to him or her. Additionally, generic plan offerings tend to cause subscribers to move from one mobile communication provider to another.

### SUMMARY

In one embodiment of the present invention, a method for providing a mobile communication plan offering includes performing using a data processing system:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system.

In another embodiment of the present invention, a method includes:

performing using a data processing system:
sending a request for one or more mobile communication plan offerings for a subscriber associated with a mobile communication device; and
receiving the one or more mobile communication plan offerings, wherein the mobile communication plan offerings are determined by:
   analyzing mobile communication device usage data of a mobile communication device associated with a subscriber; and
   identifying one or more mobile communication plan offerings based on the usage data of the mobile communication device associated with the subscriber that provide a positive economic benefit to the mobile communication device subscriber.

In a further embodiment of the present invention, a system for providing a mobile communication plan offering includes a processor and a memory, coupled to the processor. The memory includes code stored therein and executable by the processor for:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system.

In another embodiment of the present invention, a non-transitory, computer readable medium having code stored therein and executable by a processor for:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary mobile communication plan offering usage analysis system.

FIG. 2 depicts an exemplary mobile communication plan offering usage analysis method.

FIG. 3 depicts a table of usage type, timeframes, and triggering events developed from usage data.

FIG. 4 depicts exemplary mobile communication plan offers.

FIG. 5 depicts an exemplary subscriber triggering and communication events.

FIG. 6 depicts an exemplary mobile communication plan system.

FIG. 7 depicts an exemplary plan offering generation graphical user interface.

FIG. 8 depicts an exemplary computer system.

### DETAILED DESCRIPTION

In at least one embodiment, a mobile communication plan offering system and method described herein determines one or more best fit mobile communication plan offers for mobile communication device (“MCD”) users. Subscribers can also be referred to as “mobile subscribers” or “subscribers”. The mobile communication plan offers typically consist of one or more modifications to a plan (also referred to as packs) or a complete plan including a base plan plus a pack and are based on a mobile usage pattern of a subscriber. In at least one embodiment, the only usage data used to determine one or more mobile communication plan offerings for a subscriber is the usage data of the subscriber. Thus, each mobile communication plan offering communicated to the subscriber is tailored to the subscriber and provides a best-fit for the subscriber.

In at least one embodiment, the mobile communication plan offering system and method analyzes MCD usage behavior of a subscriber, processes the usage behavior and current spending of the subscriber, and determines a mobile communication plan offering that, if adopted, will result in a positive economic benefit to the subscriber compared with the subscriber's current plan. In at least one embodiment, the mobile communication plan offering system and method communicates the mobile communication plan offering to the MCD of the subscriber at an opportune time in accordance with a particular event, such as when a number of SMS messages or subscriber trunk dialing (STD) calls exceed a predetermined threshold within a predetermined timeframe and/or when a current usage limit is about to be exceeded. In at least one embodiment, in addition to communicating the particular mobile communication plan offer(s), the mobile communication plan offering system and method also communicates the particular economic benefit to be conveyed to the subscriber upon adoption of the mobile communication plan offer.

The mobile communication plan offering system and method can be implemented and operated by a mobile communication plan provider, such as a mobile communication company, or offered as a service to the mobile communication plan provider.

In at least one embodiment, the mobile communication plan offering method and system aims for a “right offer at the right time” with an objective economic analysis of the subscriber's mobile usage.

In at least one embodiment, the mobile communication plan offering method and system can be extended into a generic solution involving the marketing of services that have the following characteristics:
Variable and dynamic consumption of service
Complex segmented offering with differentiated pricing (multiple service pricing plan options)

In at least one embodiment, mobile communication plan offering method and system drives subscribers to adopt MCD mobile communication plan packs that are tailored to and, thus, beneficial for the particular subscriber by providing the subscriber with a positive economic benefit. With high relevance to the subscriber, in at least one embodiment, the adoption rate by the subscriber increases relative to a large segment mobile communication plan offering. Thus, mobile communication providers can, in at least one embodiment, increase revenue and/or retain more subscribers.

In at least one embodiment, the mobile communication plan offering method and system determines and communicates the best offers based on, for example, positive economic benefit to the individual subscriber, from a complex choice of offers that maximizes the benefit to the subscriber. From the subscriber's perspective, this helps user in saving on mobile spend for his or her pattern of MCD usage. From a mobile communication plan provider's perspective, due to high relevance to the subscriber, the mobile communication plan provider can increase adoptions for their packs and increase fixed commitment revenue.

In at least one embodiment, a mobile communication plan offering method and system takes segmentation to a “single subscriber” resolution. By analyzing each individual subscriber's usage and mapping it to the available product lines, we are creating unique offers for each subscriber and communicating the exact benefits for the subscriber. The “subscriber” (also referred to herein as a “user”) is one who subscribes to a mobile communication plan. By communicating the offer at times when the user is likely to be more receptive, in at least one embodiment, a mobile communication plan offering method and system increases the likelihood of adoption—as compared to a communication made when the user is less engaged with his mobile communication device. In at least one embodiment, through a constant assessment, the mobile communication plan offering method and system can provide a direct relevance to the user's most recent usage behavior.

In at least one embodiment, the mobile communication plan offering system and method provides a trust based engagement with the subscriber that will drive higher adoption of mobile communication plan offers. This results in a win-win between mobile communication plan providers and their subscribers—mobile communication plan providers benefit via improved adoptions and subscribers benefit both economically (by adopting the offers) and by way of reduced “spam” on their MCD.

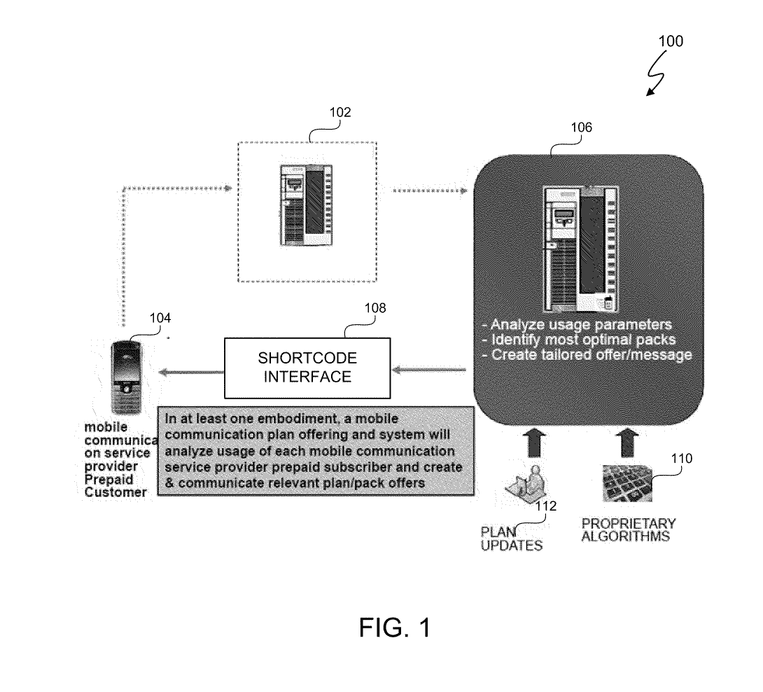

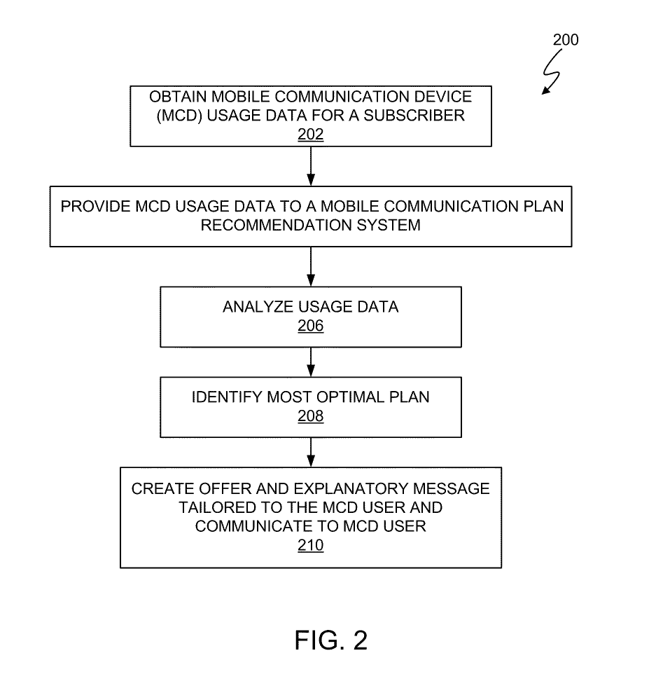

FIG. 1 depicts an exemplary mobile communication plan offering usage analysis system 100. FIG. 2 depicts an exemplary mobile communication plan offering usage analysis method 200. Mobile communication plan providers develop new mobile communication plan offers such as new plans and new add-on packs (also referred to as a “plan”) that offer specific benefits such as “1,000 text messages for $5”. Referring to FIGS. 1 and 2, in at least one embodiment, mobile communication plan offering usage analysis system 100 operates in accordance with mobile communication plan offering usage analysis method 200. In operation 202, the MCD usage collection system 102 obtains usage data from the MCD 104. Usage data can also be obtained in any number of other ways. For example, usage data can be obtained directly from the subscriber/user of MCD 104, such as the subscriber entering the usage data electronically through, for example, a web site, and the data is accessed by the MCD usage collection system 102. The usage data can also be, for example, obtained by analyzing a subscriber's bills related to MCD usage. In at least one embodiment, the MCD usage collection system 102 is an electronic computer-based data processing system. In operation 204, the usage data is provided by the MCD usage collection system 102 to a mobile communication plan recommendation system 106. Although the MCD usage collection system 102 and mobile communication plan recommendation system 106 are depicted separately, they can be integrated into a single data processing system.

The mobile communication plan recommendation system 106 analyzes the usage data in operation 206. In at least one embodiment, operation 206 analyzes both long term (30-90 days) and short term (2-7 days) usage of the subscriber. In at least one embodiment, operation 206 executes on a prescheduled basis such as once in a specified time period, such as two days. In at least one embodiment, the operation 206 executes upon request for mobile communication plan offering. Operation 208 identifies the most relevant mobile communication plan for the subscriber based on the analysis in operation 206 in, for example, terms of the maximum economic benefit the subscriber can derive by adopting a mobile communication plan offer. Operation 210 creates one or more mobile communication plan offers and accompanying explanatory messages that are tailored toward the subscriber associated with MCD 104. In at least one embodiment, operation 210 communicates the mobile communication plan offer to the subscriber during specific times that are likely to entail a higher adoption rate. The particular analysis of the usage data to identify the one or more most optimal mobile communication plans for the MCD user is a matter of design choice and will generally be performed using proprietary algorithms 110 of the mobile communication plan provider making the offer or for whom the offer is generated. In at least one embodiment, the available mobile communication plan offerings are updated with dynamic plan updates 112 on, for example, a regular basis such as every 48 hours. In at least one embodiment, the mobile communication plan recommendation system 106 works “dynamically”, such as every 48 hrs, to automatically analyze recent usage, understand best fit offerings for the MCD user. As subsequently described, in at least one embodiment, trigger events are used to trigger execution of operation 206.

In at least one embodiment, the only usage data used by the mobile communication plan recommendation system 106 to determine one or more mobile communication plan offerings for a subscriber is the usage data of the subscriber. Thus, each mobile communication plan offering communicated to the subscriber is tailored to the subscriber and provides a best-fit for the subscriber.

In at least one embodiment, the mobile communication plan recommendation system 106 communicates the exact nature of the benefits of the offer to the MCD 104 via a short code interface 108.

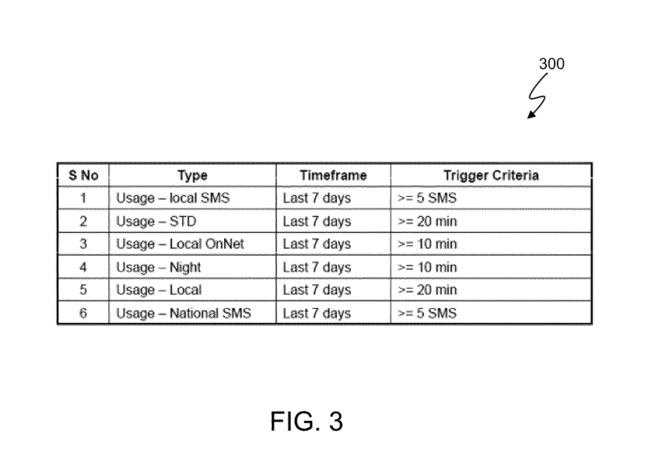

FIG. 3 depicts an exemplary table of usage type, timeframes, and triggering events developed from usage data for six subscribers S Nos. 1-6. In at least one embodiment, the mobile communication plan recommendation system 106 operation 206 compares the usage data for MCD users with triggering events. Triggering events include types of usage and associated usage amounts, for example, a number of SMS messages, night usage, local usage, in network “OnNet” usage, standard trunk dialling (STD) usage, and national SMS usage. The particular triggering events are a matter of design choice and are virtually limitless. The particular triggering criterion is also a matter of design choice and is virtually limitless. Exemplary triggering criteria are time, number of messages, amount of savings, such as greater than or equal to 5%, from adoption of a different plan, etc. In at least one embodiment, even triggers are not used to trigger operation 206.

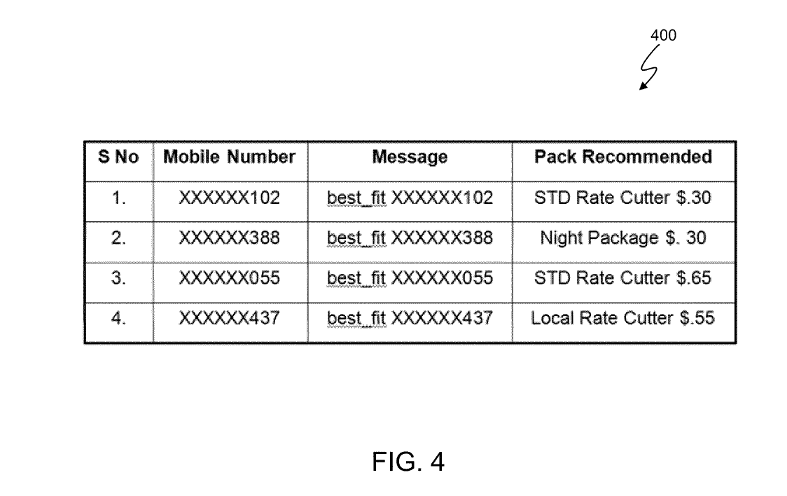

FIG. 4 depicts exemplary mobile communication plan offers to four subscribers S Nos. 1-4. In at least one embodiment, one or more mobile communication plan offers are individualized for and communicated via a message to a particular MCD, such as MCD 104, using the mobile number of the respective MCDs. A message is communicated to the MCD 104 that communicates the recommended offer(s) and, in at least one embodiment, also communicates the positive economic benefit (savings) that the MCD user will receive upon adoption of the offer. In at least one embodiment, each offer is a service “pack” which is a plan that modifies an existing plan. For example, an MCD user may have a base plan that requires a base fee for a number of services. A pack offer, for example, modifies the pricing of one of these services, such as providing better STD rates, better night rates, or better local rates.

In at least one embodiment, operations 208 and 210 are performed on controlled bases. The controlled bases can be determined by programmed rules in mobile communication plan recommendation system 106. The rules can be based on proactive and reactive events. Proactive events are, for example, the passage of a predetermined amount of time, such as 2 weeks or 1 month. Reactive events are, for example, responsive to triggers as previously described. Thus, in at least one embodiment, in order to avoid annoying or saturating an MCD user, operation 210 is performed a limited number of times, such as 2 messages per month for proactive events, and 2 messages per week for reactive events. In at least one embodiment, operation 210 is performed upon receipt of a request by the MCD user for a mobile communication plan offer.

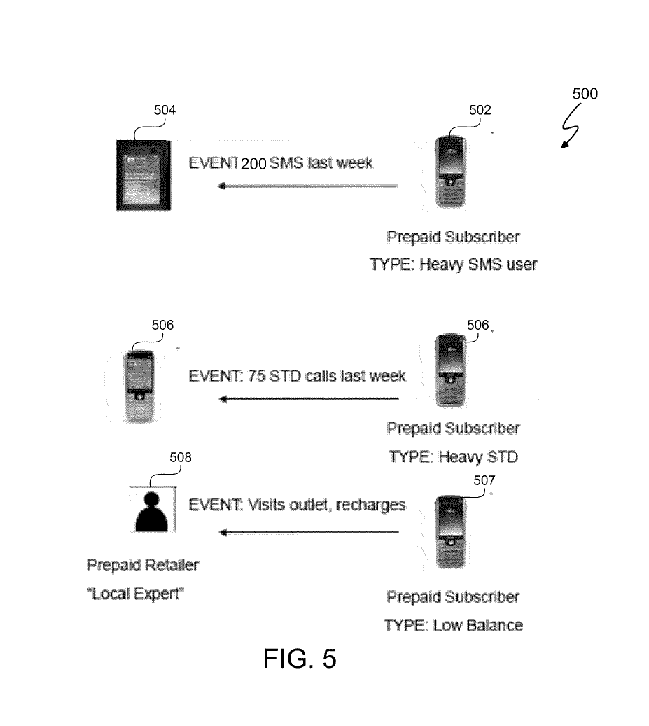

FIG. 5 depicts an exemplary subscriber triggering and communication events 500. A first subscriber of MCD 502 is a heavy SMS subscriber. Upon reaching a triggering event of 200 SMS messages in the previous week, the mobile communication plan recommendation system 106 sends an offer and explanatory message in accordance with operation 210 for display on a computing device 504 that is accessible to the first subscriber. A second subscriber of MCD 504 is a heavy STD call subscriber. Upon reaching a triggering event of 75 STD calls in the previous week, the mobile communication plan recommendation system 106 sends an offer and explanatory message in accordance with operation 210 for display on MCD 506. A third subscriber of MCD 507 is a heavy STD call subscriber. Upon reaching a triggering event of a low account balance, the subscriber of MCD 507 meets personally with a prepaid retailer 508 who can add (“Top Up”) the balance of the MCD 507. The mobile communication plan recommendation system 106 communicates the mobile communication plan offer to the prepaid retailer 508 who then informs the subscriber of MCD 507.

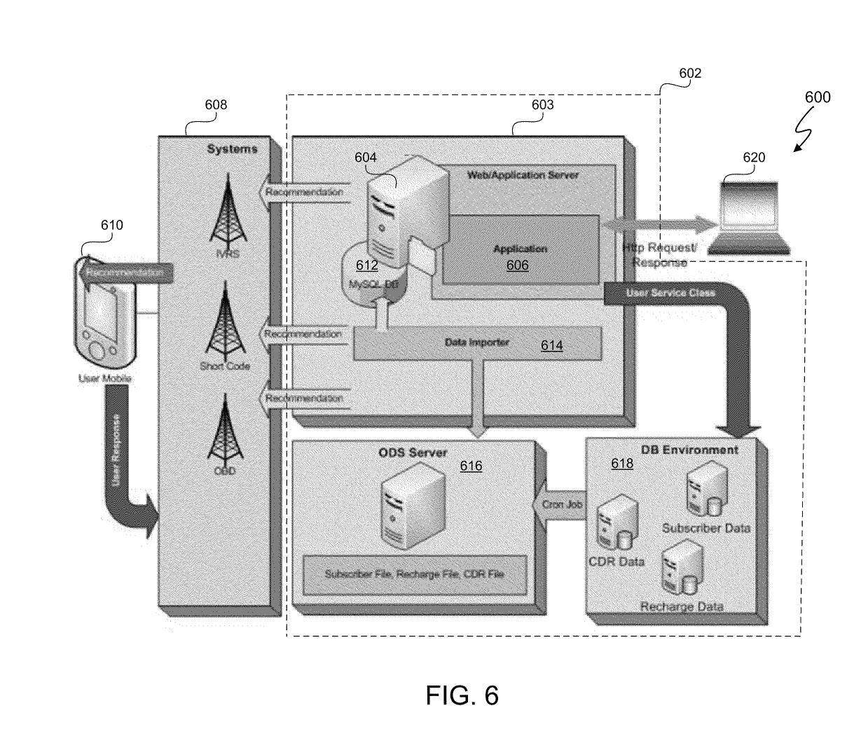

FIG. 6 depicts an exemplary mobile communication plan offering system 600 that includes a mobile communication plan system 602. In at least one embodiment, the MCD usage collection system 102 and mobile communication plan recommendation system 106 are implemented by the mobile communication plan system 602. The mobile communication plan system 602 includes a mobile communication plan offer generation system 603. The mobile communication plan offer generation system 603 is a data processing system that, in at least one embodiment, performs the mobile communication plan offering usage analysis method 200. The mobile communication plan offer generation system 603 includes a computer system server 604 that executes a software application 606. In at least one embodiment, the software application 606 implements the mobile communication plan offering usage analysis method 200 when executed by the server 605. The mobile communication plan offer generation system 603 provides the mobile communication plan recommendations (offerings) to mobile communication plan provider data processing systems 608 via a preferred communication interface of the each of the mobile communication plan provider data processing systems 608. The communication interfaces include interactive voice response systems (IVRS), short code, and OBD.

The mobile communication plan system 602 communicates mobile communication plan offerings (recommendations) to the MCD 610 in accordance with operation 210 (FIG. 2). In at least one embodiment, the subscriber (user) of the MCD 610 adopts the offering by sending an adoption response to the mobile communication plan system 602 via the mobile communication plan provider data processing systems 608.

In at least one embodiment, the mobile communication plan offer generation system 603 determines the one or more offerings to communicate to the MCD 610 by accessing data in a database 612, such as a MySQL database. The data includes a subscriber file that contains information about the subscriber and the subscriber's mobile communication plan, a recharge file that includes information on the recharge of the subscriber's balance, and a call detail records (CDR) of the subscriber. In at least one embodiment, the data in database 612 is obtained using a data importer 614 via, the open domain server (ODS) 616 which in turn obtains the subscriber data, recharge data, and CDR data via database environment 618.

In at least one embodiment, the mobile communication plan offer generation system 603 also responds to requests for mobile communication plan offerings from an Internet connected system such as the computer system 620. In responding to a request, the mobile communication plan offer generation system 603 performs mobile communication plan offering usage analysis method 200. The mobile communication plan offer generation system 603 can also proactively or reactively provide one or more mobile communication plan offerings for the subscriber associated with MCD 610 by communicating the one or more offerings to the subscriber via computer system 620. The mobile communication plan offer generation system 603 can also respond to a request for one or more mobile communication plan offerings from MCD 610 by communicating the one or more offerings to the subscriber via computer system 620.

In at least one embodiment, the mobile communication plan system 602 is operated by a mobile communication plan provider. In at least one embodiment, the mobile communication plan offer generation system 603 is operated by an mobile communication plan offering entity that provides mobile communication plan offerings to the mobile communication plan provider data processing systems 608 who can either pass the offer to the MCD 610 or decline the offer.

As previously discussed, in at least one embodiment, the mobile communication plan offer generation system 603 is operated by a separate entity than the mobile communication plan provider. In this configuration, the mobile communication plan offer generation system 603:

Integrates with mobile communication service provider's prepaid user database

Builds and hosts capability to analyze prepaid user base of mobile communication service provider

Creates customized offers for users and communicate the same on a periodic basis

Ensures mobile communication service provider prepaid plans and packs are kept up to date nationally

In at least one embodiment, the mobile communication plan provider data processing systems 608 roles include:

a mobile communication plan offering and system to access prepaid usage database; and

Updating, a mobile communication plan offering and system with plan/pack changes/introductions etc.

Following is an exemplary embodiment and example of mobile communication plan offering usage analysis method 200:

In at least one embodiment, operation 202 obtains mobile communication device usage data through an interface with ODS server 218. The data is in an Excel file. The Excel file includes four types of data:

| | | |
|---|---|---|
| 1. Subscriber Details | | |
| SUBSCRIBER RELATED | | |
| Account Activation Date | | |
| MSISDN Number | SUBSCRIBER_NUMBER | NUMBER(15), |

2. Account Details
SUBSCRIBER ACCOUNT SUMMARY
Tariff Plan Name
Tariff Plan ID
Validity Date
Recharge Date
Recharge Amount
Pack Name
Pack Id
Package Validity Date
Discount Id
Discount Name
Balance Amount
3. Call Details
SUBSCRIBER CALL
DETAILS FORMAT

| | | |
|---|---|---|
| Date | ORIGINAL_TIMESTAMP | DATE, |
| Start Time | | |
| End Time | | |
| Duration | DURATION | NUMBER, |
| Destination | CALLED_PARTY | VARCHAR2(30 BYTE), |
| MSISDN | | |
| Call type: | TELESERVICE_DESC | VARCHAR2(200 BYTE), |
| SMS/Voice | | |
| Distance type: | | |
| Local/National | | |
| Home/Roaming | | |
| identifier | | |
| Charge amount | FNL_CHRG_CALL | NUMBER(12,2), |

4. Mobile Communication Plan Offering
PLAN/PACK/DISCOUNT DETAILS
Tariff plan rate fields: local (onnet...), std (..), roaming ( ), intl ( )
Package Details fields
Discount Details fields

The mobile communication plan offer generation system 603 analyzes the subscriber usage data by processing the data based on, for example, raw call records obtained from the databases 620. In at least one embodiment, operation 206 takes the following steps are taken in at least one embodiment:
1.1. If call details are unavailable in an account-wise manner, then the raw data obtained in (1) is aggregated account-wise. That is, all the call entries for a given number should be combined.
1.2. The period for the analysis should be modifiable (1 month, 90 days, etc.)
1.3. For each of the accounts obtained in 1.1, generate aggregate usage statistics similar to the usage details input in an embodiment of a mobile communication plan offering and system web-page. The details are given in the table below:

### Aggregated Usage Statistics

TABLE 1

| | Mobiles | Mobiles | |
|---|---|---|---|
| | (Same Network) | (Outside Network) | Landline |
| Local Call Minutes | ✓ | ✓ | ✓ |
| STD Call Minutes | ✓ | ✓ | ✓ |
| SMS Local | ✓ | ✓ | — |
| SMS National | ✓ | ✓ | — |
| Roaming Incoming | ✓ | | |
| Roaming Outgoing | ✓ | ✓ | ✓ |
| International Call * | ✓ | ✓ | ✓ |
| International SMS * | ✓ | ✓ | ✓ |

In at least one embodiment, mobile communication plans are created as follows:
1.1 Phase I: In the first phase, an embodiment of a mobile communication plan offering and system plan manager can be extended to support prepaid plans and packs. The additional features required are given below:
   1.1.1. Ability to mark a plan/pack as prepaid or postpaid. For plan entry there could be two tabs: “manage postpaid plans” and “manage prepaid plans”. When recommendations are being calculated, it should be ensured that postpaid plans and packs are not combined with prepaid plans and packs. E.g. system should not recommend postpaid plan+prepaid pack
   1.1.2. All amounts prepaid would already include the service tax. The service tax % is same for postpaid and prepaid and it should be configurable.
   1.1.3. Three additional fields are added to prepaid plans:
      1.1.3.1. Starter pack: For starter packs this field should be checked (i.e., marked true). If the subscriber is requesting a new prepaid plan, then a starter pack should be included in the mobile communication plan offering. In this case, the mobile communication plan offering will look like Starter Pack+Talktime/Validity+Value Packs.
      1.1.3.2. Talktime: Amount in desired currency. This may be zero (starter packs, STD/SMS packs)
      1.1.3.3. Validity: Validity in days. Validity represents the duration of the mobile communication plan offering.
   1.1.4. Support for recharge range. Some mobile communication plan providers may support a range of recharge options. An example is given below in Table 2:

TABLE 2

| MRP | | Service Tax | | Processing | Talktime | | | |
|---|---|---|---|---|---|---|---|---|
| From | To | From | To | Fees | From | To | Validity | Description |
| 101 | 118 | 9.43 | 11.02 | 0 | 89.9 | 105 | 0 | Top up |
| 119 | 119 | 11.11 | 11.11 | 105.91 | 0 | 0 | 0 | 3 Months Local |
| | | | | | | | | STV: with I2I @ |
| | | | | | | | | 25 p/min, I2 other |
| | | | | | | | | local @ |
| | | | | | | | | 50 p/min |
| 120 | 148 | 11.21 | 13.82 | 0 | 106.8 | 131.7 | 0 | Top up |
| 149 | 149 | 13.91 | 13.91 | 85.09 | 0 | 0 | 0 | I2I Unlimited |
| | | | | | | | | Pack |
| 150 | 198 | 14.01 | 18.49 | 0 | 133.5 | 176.2 | 0 | Top up |
| 200 | 200 | 18.68 | 18.68 | 178 | 0 | 0 | 0 | 6 Months Local |
| | | | | | | | | STV: with I2I @ |
| | | | | | | | | 25 p/min, 12 other |
| | | | | | | | | local @ |
| | | | | | | | | 50 p/min |
| 201 | 221 | 18.77 | 20.64 | 0 | 178.9 | 9612 | 0 | Top up |
| 222 | 222 | 20.7 | 20.7 | −20.7 | 222 | 222 | 0 | Valid until 30th |
| | | | | | | | | June |
| 223 | 332 | 20.8 | 31 | 0 | 202.2 | 301 | 0 | Top up |
| 333 | 333 | 31.1 | 31.1 | −31.1 | 333 | 333 | 0 | 33 Min I2I free |
| | | | | | | | | for 11 days. |
| | | | | | | | | Offer valid till |
| | | | | | | | | 30th June |
| 334 | 554 | 31.2 | 51.7 | 0 | 302.8 | 502.3 | 0 | Top up |
| 555 | 555 | 51.8 | 51.8 | 0 | 503.2 | 503.2 | 0 | Top up |
| 556 | 665 | 51.9 | 93.2 | 0 | 504.1 | 904.8 | 0 | Top up |
| 666 | 666 | 62.19 | 62.19 | 0 | 603.81 | 0 | | Top up |
| 667 | 998 | 62.29 | 93.19 | 0 | 604.7 | 904.8 | | Top up |
| 999 | 999 | 93.3 | 93.3 | 0 | 905.7 | 0 | 0 | Top up |
| 1000 | 10800 | 93.4 | 1008.5 | 0 | 906.6 | 9791.5 | 0 | Top up |

In at least one embodiment, the mobile communication plan provider should allow flexibility to input both types of plans and packs into the mobile communication plan offering system 600. The mobile communication plan provider should allow ranges to be input for each plan/pack. There will be lower & upper limits to each pack for:
MRP
Service Tax
Talktime

For such plans, the prepaid recommendation engine should suggest the exact amount to recharge to optimize mobile spend. For other mobile communication plan providers with simpler recharge options, the upper and lower limits of each plan can be the same. An example is given in Table 3 below.

TABLE 3

| Currency | Calling value | Proc Fee | Service tax | Validity |
|---|---|---|---|---|
| Amount | (currency) | (currency) | (Currency) | Days |
| 50 | 43.33 | 2.0 | 4.67 | 30 |
| 100 | 88.66 | 2.0 | 9.34 | 30 |
| 200 | 179.32 | 2.0 | 18.68 | 30 |
| 300 | 269.99 | 2.0 | 28.01 | 30 |
| 500 | 451.31 | 2.0 | 46.69 | 30 |
| 1000 | 904.62 | 2.0 | 93.38 | 30 |

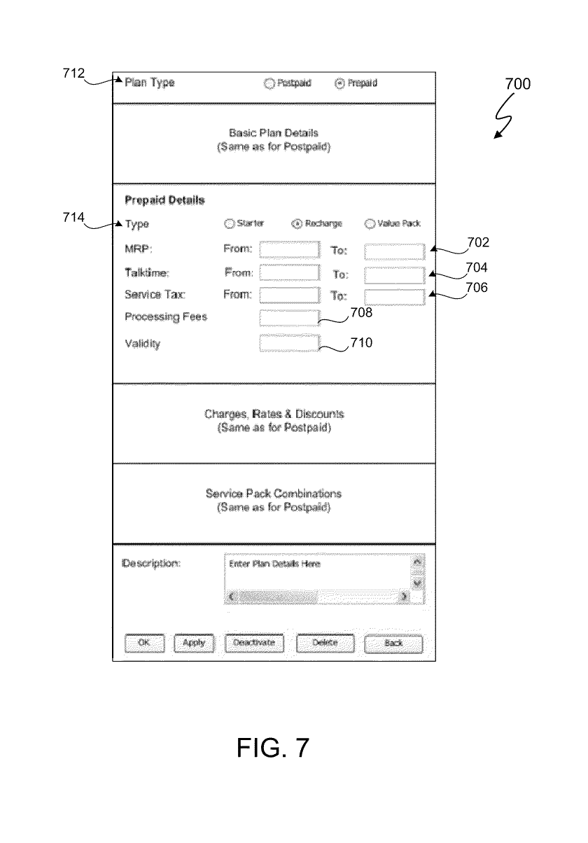

FIG. 7 depicts an exemplary plan offering generation graphical user interface 700 that allows a user to create mobile communication plan offerings. The plan offering generation graphical user interface 700 allows a user to enter pricing data 702, talk time data 704, service tax data 706, processing fees 708, and validity duration 710. The user can also select radial buttons to select a postpaid or prepaid plan type 712 and details type 714. The data entered is stored in, for example, mobile communication plan recommendation system 106 (FIG. 1).

The particular implementation of operation 208 is a matter of design choice. Following is an exemplary implementation of operation 208 and a proprietary algorithm 110 for a prepaid mobile communication plan offer:

### 1. Prepaid Recommendation Algorithm

1.1. Stage I: Account Details Unavailable:
1.1.1. For all valid combinations of subscriber's current plan & packs of the same operators, multiply the usage entered in the wizard with the appropriate rate to get an estimated monthly spend on that plan+pack combination. Add service taxes (10%-check) to get actual spend on recharge coupons.
1.1.2. Add the cost of one month of validity for the value pack.
1.1.3. Arrange the recommended packs (not plan+pack) in order of increasing average spend. Display the top X packs in the recommendations window.
1.1.4. Show the additional columns of ‘additional savings’ and ‘Savings Analysis’ as described in 4.1.2.1 above.
1.1.5. The SMS should be The SMS's should be customized. An example SMS would be: “Based on your usage, you can save [insert amount] monthly by purchasing Pack ABC”. The amount inserted is configurable.

1.2. Stage II: Account Information Available:
A prepaid subscriber's usage behavior is influenced by two major factors—account balance and remaining validity.
If the remaining account validity is less than X then the account is said to have low validity, otherwise it has high balance.
If the remaining account balance is less than X then the account is said to have low balance, otherwise it has high balance.
The matrix below gives the priority of a subscriber's purchase decisions based on the above two factors. A lower rank indicates higher priority. The subscriber should be sent mobile communication plan offers targeted at the Balance Low/Validity Low 1, 2, and 3, Balance High/Validity Low 1 and 2, Balance Low/Validity Low 1 and 2, and Balance High/Validity High 1 in Table.

TABLE 4

Validity

| | | Low | High |
|---|---|---|---|
| Balance | Low | 1. Validity | 1. Talk time |
| | | 2. Talk time | 2. Other Packs |
| | | 3. Other Packs | 3. Validity |
| | High | 1. Validity | 1. Value Packs |
| | | 2. Other Packs | 2. Talk time/validity |
| | | 3. Talk time | |

The mobile communication plan offerings from Table 4 are communicated in an exemplary embodiment of operation 210 as follows:

Scenario I: Low Balance and Low Validity

In this scenario, a subscriber will be interested in increasing both validity as well as balance. While recharging the subscriber will also be looking at packs that help reduce call charges or provide value added services.

In this case the subscriber should be sent SMS's related to all the three purchase options.

Scenario II: Low Balance and High Validity

The subscriber will primarily be interested in getting additional talk-time and other packs that help reduce call charges or provide VAS.

In this case the subscriber should be sent SMS's related to talk-time top-ups and other packs.

Scenario III: High Balance and Low Validity

The subscriber will be looking at increasing the account validity.

In this case the subscriber should be sent SMS's related to validity top-ups and other packs.

Scenario IV: High Balance and High Validity

In this case the subscriber should be sent SMS's related to other packs only.

In at least one embodiment, in addition to validity and account balance, the current pack subscriptions of the subscriber should be tracked. If a pack is about to expire, then an SMS reminding the subscriber to recharge that pack should be sent. In all the above cases, the SMS's sent should be customized based on the subscriber's usage pattern. In each of the SMS's specify the estimated savings for the user if he/she purchases the plan/pack. Example SMS: “Based on your usage analysis, you can save $100 annually by subscribing to SMS 50 pack. Dial 131 to subscribe now!”

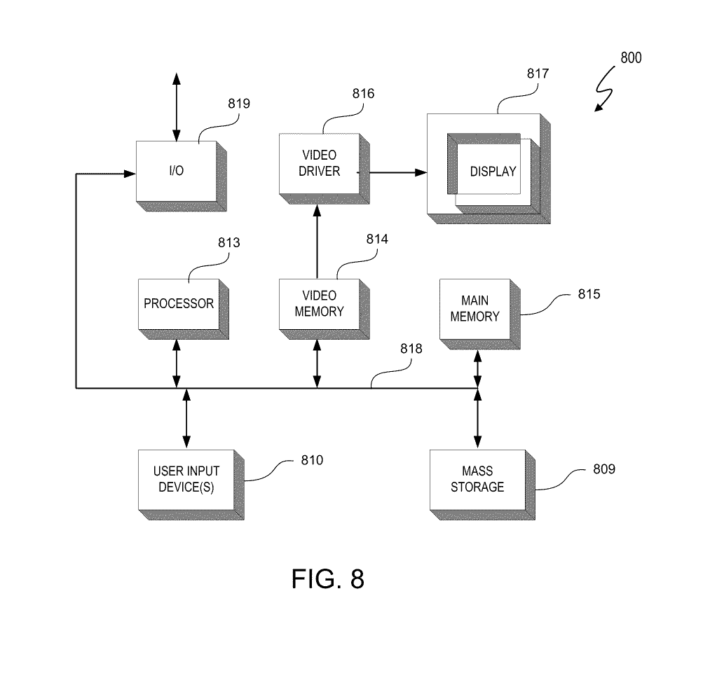

Embodiments of the mobile communication plan offer generation system 603 and ODS server 616 can be respectively implemented on a computer system such as a general-purpose computer 800 illustrated in FIG. 8. Input user device(s) 810, such as a keyboard and/or mouse, are coupled to a bi-directional system bus 818. The input user device(s) 810 are for introducing user input to the computer system and communicating that user input to processor 813. The computer system of FIG. 8 generally also includes a video memory 814, main memory 815 and mass storage 809, all coupled to bi-directional system bus 818 along with input user device(s) 810 and processor 813. The mass storage 809 may include both fixed and removable media, such as other available mass storage technology. Bus 818 may contain, for example, 32 address lines for addressing video memory 814 or main memory 815. The system bus 818 also includes, for example, an n-bit data bus for transferring DATA between and among the components, such as CPU 809, main memory 815, video memory 814 and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer system via a telephone link or to the Internet via an ISP. I/O device(s) 819 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in a non-transitory, tangible mass storage 809 until loaded into main memory 815 for execution. Computer programs may also be in the form of electronic signals modulated in accordance with the computer program and data communication technology when transferred via a network.

The processor 813, in one embodiment, is a microprocessor manufactured by Motorola Inc. of Illinois, Intel Corporation of California (such as a Basic Server Quad core 2CPU (Intel Xeon X5550)/16 GB random access memory/1.2 TB hard drive), or Advanced Micro Devices of California. However, any other suitable single or multiple microprocessors or microcomputers may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the display 817. Video amplifier 816 is well known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The mobile communication plan offering usage analysis method 200 can be implemented as code, stored in a non-transitory, computer readable medium, and executed by the server 604. Exemplary computer readable mediums are compact disks, digital versatile disks, flash memories, hard drives, and any other type of non-transitory computer readable medium.

The mobile communication plan provider data processing systems 608 can be implemented in accordance with well known mobile communication plan provider data processing systems such as AT&T, Verizon, Sprint, T-Mobile, AirTel, and Vodafone.

Although the present invention has been described in detail, it should be understood that various changes, substitutions and alterations can be made hereto without departing from the spirit and scope of the invention.

What is claimed is:

1. A method for providing a mobile communication plan offering, the method comprising:
performing using a data processing system:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system.

2. The method of claim 1 wherein the electronic system is the mobile communication device associated with the subscriber.

3. The method of claim 1 wherein the entity is a data processing system of a mobile communication plan provider.

4. The method of claim 1 further comprising:
developing the one or more communication plan offerings.

5. The method of claim 1 wherein communicating further comprises communicating the identified one or more mobile communication plan offerings to the entity proactively.

6. The method of claim 1 wherein communicating further comprises communicating the identified one or more mobile communication plan offerings to the entity reactively in accordance with a triggering event.

7. The method of claim 6 wherein the triggering event is a member of a group consisting of: types of usage and associated usage amounts and account balance levels.

8. The method of claim 1 further comprising:
receiving a response from the subscriber indicating adoption of one of the one or more mobile communication plan offerings.

9. The method of claim 1 wherein analyzing further comprises analyzing the mobile communication device usage data on a prescheduled basis.

10. The method of claim 1 wherein analyzing further comprises analyzing the mobile communication device usage data upon request for mobile communication plan offering.

11. A method comprising:
performing using a data processing system:
sending a request for one or more mobile communication plan offerings for a subscriber associated with a mobile communication device; and
receiving the one or more mobile communication plan offerings, wherein the mobile communication plan offerings are determined by:
analyzing mobile communication device usage data of a mobile communication device associated with a subscriber; and
identifying one or more mobile communication plan offerings based on the usage data of the mobile communication device associated with the subscriber that provide a positive economic benefit to the mobile communication device subscriber.

12. A system for providing a mobile communication plan offering, the system comprising:
a processor; and
a memory, coupled to the processor, wherein the memory includes code stored therein and executable by the processor for:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system.

13. The system of claim 12 wherein the electronic system is the mobile communication device associated with the subscriber.

14. The system of claim 12 wherein the entity is a data processing system of a mobile communication plan provider.

15. The system of claim 12 wherein the code is further executable by the processor for:
developing the one or more communication plan offerings.

16. The system of claim 12 wherein the code for communicating is further executable by the processor for communicating the identified one or more mobile communication plan offerings to the entity proactively.

17. The system of claim 12 wherein the code for communicating is further executable by the processor for communicating the identified one or more mobile communication plan offerings to the entity reactively in accordance with a triggering event.

18. The system of claim 17 wherein the triggering event is a member of a group consisting of: types of usage and associated usage amounts and account balance levels.

19. The system of claim 12 wherein the code is further executable by the processor for:
receiving a response from the subscriber indicating adoption of one of the one or more mobile communication plan offerings.

20. The system of claim 12 wherein the code for analyzing is further executable by the processor for analyzing the mobile communication device usage data on a prescheduled basis.

21. The system of claim 12 wherein the code for analyzing is further executable by the processor for analyzing the mobile communication device usage data upon request for mobile communication plan offering.

22. A non-transitory, computer readable medium having code stored therein and executable by a processor for:
analyzing mobile communication device usage data of a mobile communication device associated with a subscriber;
identifying one or more mobile communication plan offerings based on the usage data of the mobile communication device associated with the subscriber that provide a positive economic benefit to the mobile communication device subscriber; and
communicating the identified one or more mobile communication plan offerings to an electronic system.

23. The computer readable medium of claim 22 wherein the electronic computer readable medium is the mobile communication device associated with the subscriber.

24. The computer readable medium of claim 22 wherein the entity is a data processing computer readable medium of a mobile communication plan provider.

25. The computer readable medium of claim 22 wherein the code is further executable by the processor for:
developing the one or more communication plan offerings.

26. The computer readable medium of claim 22 wherein the code for communicating is further executable by the processor for communicating the identified one or more mobile communication plan offerings to the entity proactively.

27. The computer readable medium of claim 22 wherein the code for communicating is further executable by the processor for communicating the identified one or more mobile communication plan offerings to the entity reactively in accordance with a triggering event.

28. The computer readable medium of claim 27 wherein the triggering event is a member of a group consisting of: types of usage and associated usage amounts and account balance levels.

29. The computer readable medium of claim 22 wherein the code is further executable by the processor for:
receiving a response from the subscriber indicating adoption of one of the one or more mobile communication plan offerings.

30. The computer readable medium of claim 22 wherein the code for analyzing is further executable by the processor for analyzing the mobile communication device usage data on a prescheduled basis.

31. The computer readable medium of claim 22 wherein the code for analyzing is further executable by the processor for analyzing the mobile communication device usage data upon request for mobile communication plan offering.
